(19) United States
(12) Patent Application Publication
(10) Pub. No.: US 2011/0214339 A1
(43) Pub. Date: Sep. 8, 2011

(54) Electric Pest Deterrent Tracks and Systems

(75) Inventor: Bruce Donoho, Mission Viejo, CA (US)

(73) Assignee: BIRD-B-GONE, INC., Mission Viejo, CA (US)

(21) Appl. No.: 12/716,199

(22) Filed: Mar. 2, 2010

(51) Int. Cl. A01M 1/22; H05C 3/00; A01M 23/38

(52) U.S. Cl. 43/112; 43/98

(57) ABSTRACT

Electrical deterrent systems are presented. A deterrent system can include electrical deterrent tracks comprising an insulator base and a conducting strip affixed to a top surface of the track. The bases can include one or more base connectors that allow tracks to be joined together in various configurations including area covering arrays. The conducting strips can be woven, non-woven, meshes, or other types of conductors.

### FIELD OF THE INVENTION

The field of the invention is pest repelling technologies.

### BACKGROUND

Electrical pest deterrent devices generally include two parallel electrical conductors placed near each other, where the conductors have a voltage difference between them. When a pest (e.g., insect, slug, bird, animal, etc.) comes into contact with both of the conductors, the pest receives an unpleasant electrical shock thus driving the pest away. Pests hopefully learn to avoid the deterrent, or the area.

A great deal of past effort has been directed to developing different types of electrical pest deterrents. For example, many technologies have been developed relating to electric fences to prevent large animals from crossing a boundary. Japanese patent application publications to Koyama JP 2001 000163 titled “Engergizable Electric Net for Preventing Animal”, filed Jun. 19, 2000; and JP 2003 219788 titled “animal Barrier System, Net for Animal Barrier and Ring for Fixing Animal Barrier Net”, filed Jan. 25, 2002, both provide for electrical enclosures for larger animals, including monkeys. U.S. Pat. No. 5,096,162 to Cleveland titled “Electric Fence Wire Construction”, filed Jul. 17, 1991, describes an electric fence having elongated plastic strips with wires disposed along the edges. U.S. Pat. No. 5,957,434 to Nilsson titled “Electric Fence Device” having a PCT filing date of Sep. 8, 1995, suggests an electric fence can comprise elastic string having conductive threads. Additionally, U.S. Pat. No. 6,341,550 to White titled “Electrobraid Fence”, filed May 4, 1999, suggests an electric fence could be created using braided electrical fence rope having exposed wires. To a lesser degree, U.S. Pat. No. 4,949,216 to Djukastein titled “Apparatus for Discouraging Animals for a Selected Area”, filed Jun. 17, 1988, contemplates providing a non-conducting material having conductors spread over an upper surface of the material. Although the above technologies aid in controlling large animals, the technologies do not provide a sufficient deterrent from small crawling creatures or birds.

Still, many others have attempted to provide technologies for repelling insects or gastropods through the use of electrical deterrents. For example, U.S. Pat. No. 4,471,561 to Lapierre titled “Insect Eradicator”, filed Jul. 23, 1982, discusses a base sheet of an insulating material having two electrical contacts spaced apart appropriately to shock insects. U.S. Pat. No. 4,706,941 to Sherdan titled “Snail and Slug Electrical Barrier”, filed Sep. 12, 1986, also discusses a barrier having two adjacent conductors spaced appropriately to provide an electric shock to gastropods. In a similar vein U.S. Pat. No. 4,747,229 to Chambers titled “Crawling Slug and Pest Exterminator”, filed Oct. 27, 1986, provides for conductors adjacent to each other on an elongated strip that can be used to deter slugs or other pests passing over the strip. German patent publication DE 39 30 013 also to Windhager, titled in English “Snail Defense Band—with Ribs Carrying a Pair of Live Semiconductor Cables”, filed Sep. 8, 1989, discloses a deterrent device having a flat strip of soft PVC with embedded conductors that shocks snails. U.S. Pat. No. 4,839,984 to Saunders et al. titled “Insect Guard System and Method of Use”, filed Nov. 12, 1987, describes mounting conductors on an insulating surface for prevent pests from entering a structure. U.S. Pat. No. 5,007,196 to Saunders et al. titled “Insect Guard System and Method of Use”, filed Feb. 8, 1990, discusses closely spacing elongated conductors on an insulating base to stun insects. Such systems would likely deter small, crawling creatures, but still fail to address birds.

Apparently, even more effort has been directed toward repelling birds. German patent publication DE 39 30 012 to Windhager, titled in English “Electrical Bird Scaring System e.g. for Building—has Plastic Strip with Built in Cables to Apply Mild Electric Shock”, filed Sep. 8, 1898, describes a deterrent device having an insulator base with two conducting cables configured to deter pigeons. European patent EP 0 847 690 to Negre titled in English “Electrical Bird Repelling Device”, filed Dec. 11, 1997, also describes a bird deterrent device having two conducting rails disposed within an insulator base. Great Britain patent GB 1074622 to Bramely titled “Improvements relating to Bird Scarers”, filed Dec. 31, 1965, also describes a bird deterrent device having an insulating plastic base and two conductive threads. U.S. Pat. No. 2,647,228 to Just titled “Apparatus for controlling Bird Nuisance”, filed May 12, 1949, contemplates installing an electrically charged wire adjacent to a building ledge, where a bird would receive a spark from a nearby wire. Such a system would likely be unpractical. U.S. Pat. No. 3,366,854 to Robinson titled “Pest Repelling Apparatus and Methods”, filed Apr. 21, 1965, discusses another bird deterrent device having two parallel conductors disposed on insulating bases. U.S. Pat. No. 4,015,176 to Shanahan et al. titled “Apparatus for Removing Birds and Other Pests”, filed Sep. 25, 1975, describes a system having two wires spiral wound around an elongated base. U.S. Pat. No. 4,862,637 to Dressel titled “Bird Repelling System with Improved Mounting Fixture”, filed Jan. 5, 1989, discloses yet another electrical system for repelling bird from vineyards. U.S. Pat. No. 5,850,808, to Burdick titled “System for Repelling Pests”, filed Oct. 14, 1997, contemplates a three conductor system having rigid bases and connectors to allow conductors from a first base to electrically connect with conductors of another base. Such a system requires production of many different shaped bases, which would be impractical and would lack flexibility for varied installation geometries. U.S. Pat. No. 6,314,914 to Betzen titled “Capacitor Powered Animal Repelling and Training Device without Bait”, filed Jan. 18, 2000, although short also describes two parallel conductors. U.S. patent application publication US 2009/0101080 to Selzer titled “Avian Averting System and Associated Methods”, filed Oct. 19, 2007, discusses protecting a building by installing bases having conducting elements. International patent application publication WO 95/08915 to Greenwood titled “Deterrent for Small Animals and/or Birds”, filed Apr. 13, 1993, describes placing exposed wires on an elongated insulating material. International patent application publication WO 95/08915 also to Greenwood titled “Deterrent Arrangement”, filed Sep. 30, 1994, suggests placing exposed wires within an elongated flexible base, but still suffers from lack of lateral flexibility without stressing the conductors.

Some approaches attempt to instill greater adaptability in a device to ease installation. U.S. Pat. No. 6,283,064 to Djukastein et al. titled “Pest Repelling Device”, filed Dec. 30, 1999, furthers deterring device technologies by providing for a base that can flex laterally in a plane parallel to the base. Unfortunately, bending laterally places undue stress on the conducting elements, especially the elements disposed on an outer radius of the flex. U.S. Pat. No. 6,457,283 to Jensen titled “Apparatus for Deterring Flying Animals and Method for Making the System”, filed Jun. 19, 2000, also describes a two conductor deterrent device capable of flexing laterally. A similar approach is offered by U.S. Pat. No. 6,928,768 to Snow titled “Deterrent Strip for Repelling Birds and Other Pests”, filed Feb. 19, 2004; and by U.S. Pat. No. 7,020,995 also to Snow having the same titled, filed May 13, 2004. Snow recognized that conductors would be stressed when strips are flexed laterally. Consequently, the conductors are crimped to provide greater play. Still, such an approach is limited by the amount of crimp provided. International patent application publication WO 84/04022 to Bailey titled “Bird Deterrent”, filed Apr. 19, 1984, suggests the conductors can be installed directly on an insulating surface, a fiber glass boat hull for example. Unfortunately, the approach suggest by Bailey requires significant expertise and care when installing the conductors to ensure the conductors have proper spacing between them.

Bird deterrents that offer some adaptability during installation also include U.S. Pat. No. 7,481,021 filed Dec. 4, 2003, and U.S. patent application publication 2009/0126651, filed Jan. 27, 2009, both to Riddell and titled “Electric Deterrent Device” describe that two braided connectors can be sewn to a base. Unfortunately, such a system lacks laterally flexibility due to the width of the base, and the tightly braided conductors restrict evaporation of water resulting from inclement weather. The Applicant's own technologies include co-pending U.S. patent application to Donoho having Ser. No. 12/689,406 titled “Electric Deterrent Device Having Knitted Conductors”, filed Jan. 19, 2010, which provides for knitted conductors on a deterrent device. The knitted conductors have greater porosity allowing trapped water to evaporate quickly and have a lower electrical resistant allowing for longer tracks in an installation. Unfortunately, the Riddell and Donoho devices lack lateral flexibility (e.g., flex in a plane parallel to the base), as with the Greenwood approaches.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

The trend in the art, as indicated by the known deterrent systems above, continues toward an insulator base having at least two conductors set at different voltages. Therefore the industry provides products comprising an insulator base with two affixed conductors sized and dimensions to target only a specific pest. The result is that each existing product solution suffer from many different issues due to the restrictive nature of the designs. One issue with the know art includes a lack of ability to address a varied installation topology or geometry. For example, although the Riddell solution can bend vertically around corners, the solution fails to bend horizontally due to the base width. Even if it could, the stress on the conductor at the outer radius of the bend would likely pop the conductor's stitching. Another issue with configurations having a single insulator base having plural conductors is that the spacing between the conductors is set at manufacturing time and restricts the adaptability of the device to target a variety of pests (e.g., crawling creatures, different sized birds, etc.). Yet another issue with known devices includes lack of modularity where devices can be combined as desired during installation in a manner to cover an area of a surface. For example, Burdick's solution contemplates connecting bases together to from a linear device. However, Burdick's bases are rigid and fail to provide flexibility to cover an area efficiently.

What has yet to be appreciated is electrical deterrent tracks can be produced to address many, if not all of the above issues. Rather than continuing the trend of affixing multiple conductors to an insulator base, an electrical deterrent track could have one conductor affixed to a base. Multiple tracks can be combined to create more complex configurations and fit a local installation surface's geometry. The insulator base of a track can also include one or more base connectors capable of coupling with bases of other tracks to form a linear, dual-parallel conductor deterrent device or to form an area covering array. A deterrent system constructed from such electrical deterrent tracks has greater adaptability to address requirements for flexing in many degrees of freedom (e.g., vertical bends, horizontal bends, etc.) can be manufactured quickly and easily without requiring additional modifications to address installation geometries, and has greater modularity. Tracks coupled together via their connectors ensure that the conductors are spaced appropriately for a target pest.

Thus, there is still a need for electrical deterrent tracks.

### SUMMARY OF THE INVENTION

The inventive subject matter provides apparatus, systems and methods in which a pest deterrent system comprises an electrical deterrent track having a single conductor strip. One aspect of the inventive subject matter includes a pest deterrent system comprising multiple electric deterrent tracks. In some embodiments each of the tracks includes an elongated insulator base having a conducting strip running the length of the base. The conducting strip can be affixed to the base using various suitable techniques including sewing, adhesives, friction fits, or other techniques. The insulator bases of the tracks can also include one or more base connectors that allow the base to couple to other bases, which allows for placement of the tracks in many different configurations on an installation surface. For example, two tracks could be placed next to each other to form a linear dual conductor deterrent system. Two or more tracks can also be arranged in other configurations to cover an area. The system can further include a power coupling assembly capable of supplying a voltage different between adjacent conducting strips of the tracks.

In more preferred embodiments, the tracks are fungible with respect to each other, where each track's base can comprise continuous base connectors running the length of the track, possibly formed during an extrusion process at the time of manufacture. Such a configuration allows one track to couple to other tracks, or itself, along the length of the base. It is also contemplated that spacers, possibly an elongated base lacking a conductor, can be disposed between tracks so the resulting deterrent system has proper spacing for a target pest. Different sized spacers can be deployed to adjust the spacing to target different pests.

Another aspect of the inventive subject matter includes an electrical deterrent track comprising an elongated insulator base having one or more base connectors. One or more conducting strips can be affixed to a top surface of the base. Preferably the base connectors can couple with bases of other tracks or spacers. Preferably a track comprises a single conducting strip.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a possible pest deterrent system with two tracks coupled to an electrical power supply.

FIG. 2 illustrates deterrent tracks having base connectors and a deterrent system having two tracks coupled together at their bases.

FIG. 3 is a schematic of a deterrent track having continuous base connectors and deterrent system configurations that leverage the base connectors.

FIG. 4 is a schematic of deterrent tracks having drainage notches.

FIG. 5 is a schematic of deterrent tracks having inserted rigid forms to hold a shape of the deterrent track.

FIG. 6 is a schematic of different types of conductors suitable for use with a deterrent track.

FIG. 7 presents various area covering arrays of deterrent tracks to form deterrent systems.

### DETAILED DESCRIPTION

The following discussion presents one or more aspects of the inventive subject matter from a perspective of deterring birds. One should appreciate that the disclosed techniques can be readily adapted to target many different pests including insects, rodents, gastropods, birds of various sizes, large animals, or other pests.

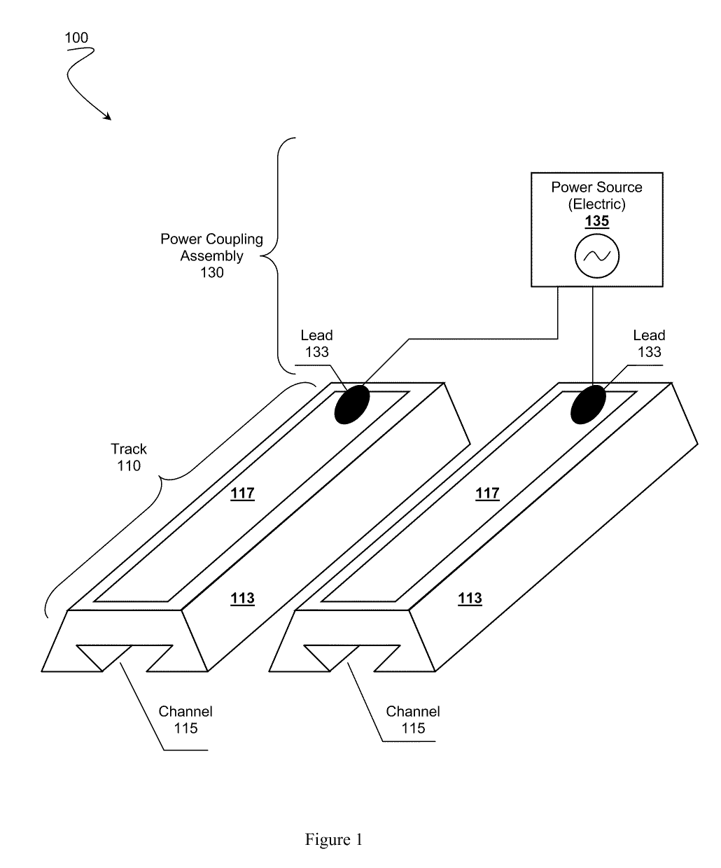

In FIG. 1, system 100 provides a basic overview relating to features of an electrical deterrent system that comprises at least two of electric deterrent track 110 and power coupling assembly 130. System 100 can include a plurality of tracks 110 arranged according to various configurations. In the example shown, two of tracks 110 are arranged adjacent to each other on an installation surface (e.g., roof, building, boat, etc.).

Electrical deterrent tracks 110 can comprise a conducting strip 117 affixed to a top surface of insulator base 113. Strip 117 can be affixed through various suitable approaches including mechanical fasteners (e.g., staples, snaps, friction fit, sewing, etc.), chemical fasteners (e.g., glue, adhesive, resins, epoxy, etc.), thermal fasteners (e.g., melting, solder, etc.), or other types of fastens capable of firmly holding strip 117 to base 113 while in outdoor conditions. More preferred fasteners, sewn stitches for example, allow strip 117 to flex as base 113 flexes vertically or horizontally.

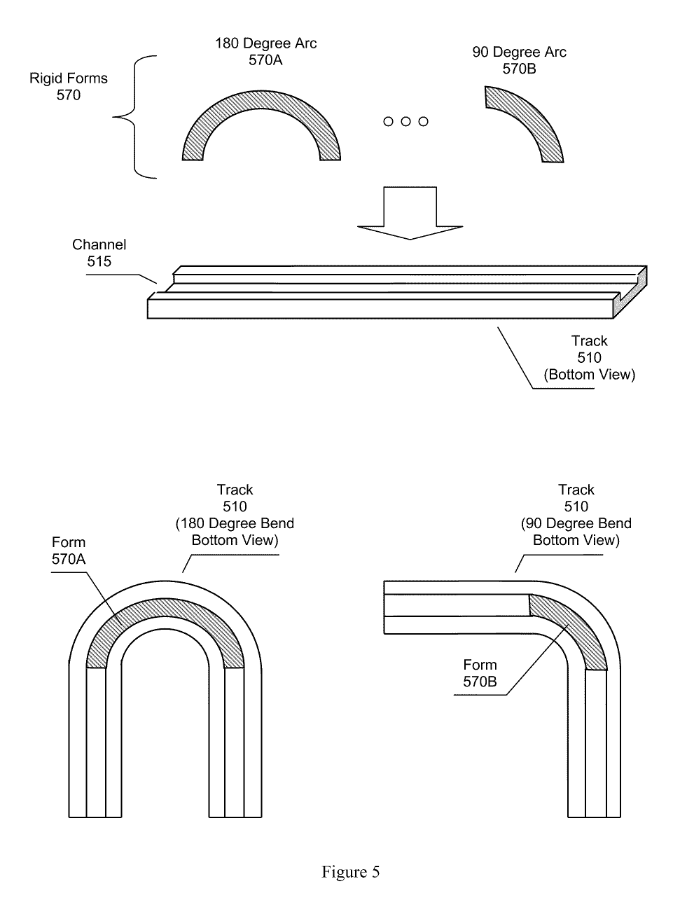

Track 110 can also include one or more of channel 115, possibly located on an underside of base 113 as illustrated. Channel 115 can serve several purposes including operating as an adhesive trough during installation, a drainage channel, or a slot into which shaped forms can be inserted to ensure track 110 retains a desired shape. A discussion regarding shaping track 110 is provided below in regards to FIG. 5.

Tracks 110 can be installed on to an installation surface using many different techniques without departing from the inventive subject matter. As mentioned, channel 115 can serve as an adhesive trough in which glue can be applied. Track 110 can then be pressed against a target surface. It is also contemplated that track 110 could be stapled to a target surface, possibly using an insulated staple.

Tracks 110 can be fungible with respect to each other. Each track 110 of a deterrent system can be substantially identical to other tracks, if desired, to allow for tracks to be replaced, repaired, or installed as desired as opposed to requiring different shapes of tracks that have specific features. Still, it is contemplated that non-fungible tracks could be utilized.

Base 113 represents a non-conducting material capable of insulating conducting strip 117 from an installation surface. Base 113 can be formed as an elongated base from a flexible material to allow track 110 to be installed in a wide variety of geometries. In some embodiments, base 113 a liquid or semi-solid material (e.g., caulk, resin, etc.), possibly based on silicone or resin that can dry or cure. In such embodiments, strip 117 could bond with the material upon drying or curing. More preferred embodiments utilize a soft solid material including Polyvinyl Chloride (PVC) that is extruded or pultruded into a base having a desired cross section shape. It is also contemplated that other materials could adapted to form flexible base 113. For example, materials that could be adapted could include fiberglass, carbon fibers, Polybutylene terephthalate (PBT), Polyethyline terephthalate (PET), or other materials could be configured to bend or flex as desired to achieve desirably flexibility.

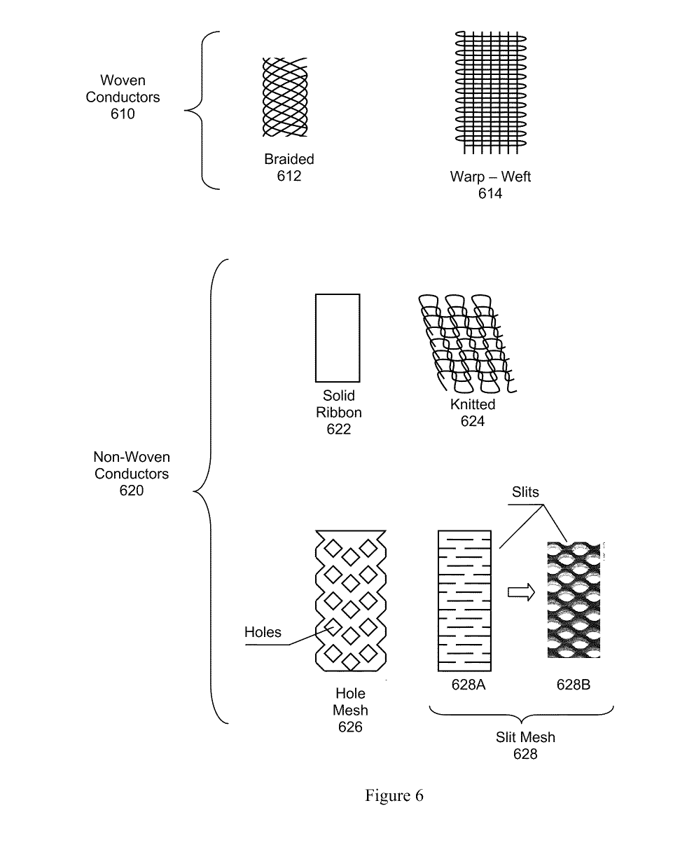

Conducting strip 117 can comprise an electrical conductor formed into a strip or ribbon and affixed along a length of base 113. Strip 117 preferably comprises a corrosion resistant conductor, possibly copper, stainless steel, or other metals. More preferred embodiments utilize a conductor having a high degree of flexibility to allow for flexing track 110 during installation on an installation surface, especially surfaces having tortuous geometries or topologies. Strip 117 preferably has a high porosity to prevent water from becoming trapped between base 113 and strip 117. For example, a flat strip of metal would likely trap water for extended periods of time increasing a corrosion rate, while a knitted conductor would allow water to quickly evaporate or drain away. Additional discussion regarding types of conductors can be found below with respect to FIG. 6.

Strip 117 can also include one or more of conductor lead 133 representing a contact point to which power source 135 can electrically connect to strip 117. Lead 133 can provide an electrical contact points via a mechanical connection (e.g., clamps, plugs, screws, bolts, friction fit, etc.), a chemical connection (e.g., glue, adhesive, epoxy, resin, etc.), a thermal connection (e.g., solder), or other types of connections. It is also contemplated that strip 117 could itself connect directly to power source 135. Although leads 133 are illustrated on base 113, one should note that leads 133 could be located off of base 113.

System 100 preferably includes power coupling assembly 130 configured to provide a voltage difference between strips 117 on tracks 110. Preferably assembly 130 includes electrical power source 135 and one or more cables or wires that electrically connect with strips 117 via leads 133.

A voltage difference between strips 117 can be generated via a D/C or an A/C power source 135. More preferred embodiments employ an A/C source configured to apply a voltage pulse periodically to strips 117. Pulses reduce power requirements and ensure that a shocked pest is able to retreat from the device or area. Acceptable power sources can include generators, solar cells, capacitors, transformers, standard electrical outlets, or other sources of electrical power.

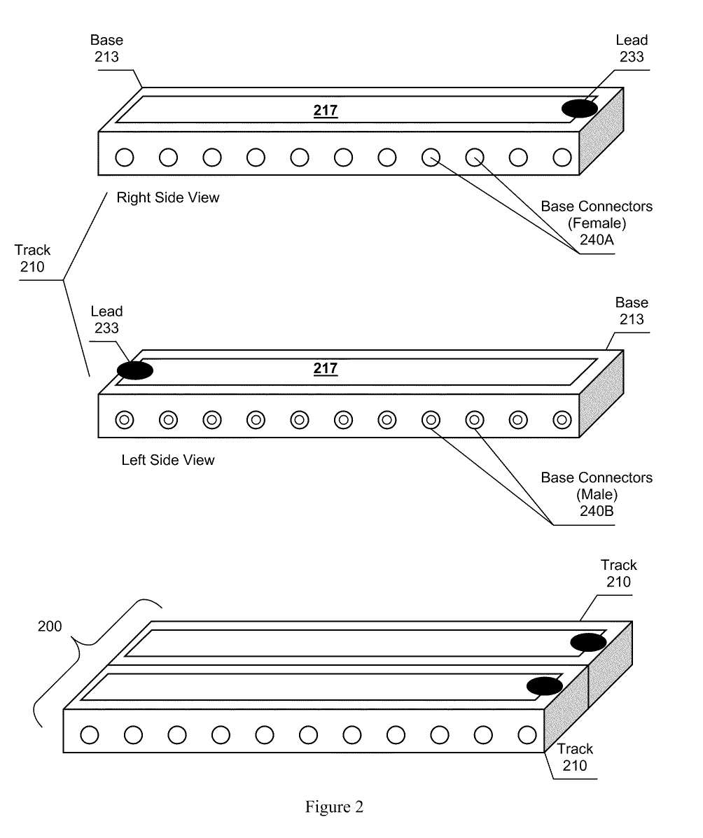

FIG. 2 presents additional possible features of electrical deterrent tracks. As in FIG. 1, track 210 includes conducting strip 117 affixed on a top surface of insulator base 213. Track 210, shown from a right side and left side perspective, can also comprises one or more of base connectors 240A and 240B, collectively referred to as base connectors 240. In the example shown, connectors 240 can include discrete female connectors 240A disposed along a side of track 210, and can include discrete male connectors 240B disposed along an opposite side of track 210. Connectors 240 allow one of track 210 to couple with another of track 210 as illustrated with respect to deterrent system 200. One should appreciates that track 210 includes a first connector capable of coupling with a second connector on track 210. Such a configuration retains the fungible nature of track 210.

Different types of connectors 240 can be mounted on track 210 as desired to meet different requirements. In some embodiments, discrete connectors 240 might be sufficient to create a dual-track, linear deterrent system 200 as illustrated. In other embodiment, continuous connectors running the length of track 210 could be advantageous to allow both tracks to slide easily against each other when installing around corners or bends. Example discrete connectors include hook-and-loop fasteners, clamps, male-female connectors (e.g., snaps, plugs, etc.), zippers, or other connectors. Example continuous connectors includes extruded male or female forms on base 213, adhesive, or other connectors that substantially run a long a length of track 210. Connectors 240 can be disposed on sides of track 210 as shown. It is also contemplated that connectors 240 could be placed on the top surface or underside of track 210 to allow overlapping tracks to connect with each other.

Connectors 240 can be integral with base 213 as in the case of an extruded continuous connector. One should note that connectors 240 can be non-integral as shown. For example, non-integral connectors (e.g., snaps, bolts, etc.) can be permanently attached during manufacture or during installation. Non-integral connectors could be free connectors that can be attached during installation. Example non-integral free connectors could include clips or clamps designed to hold bases together.

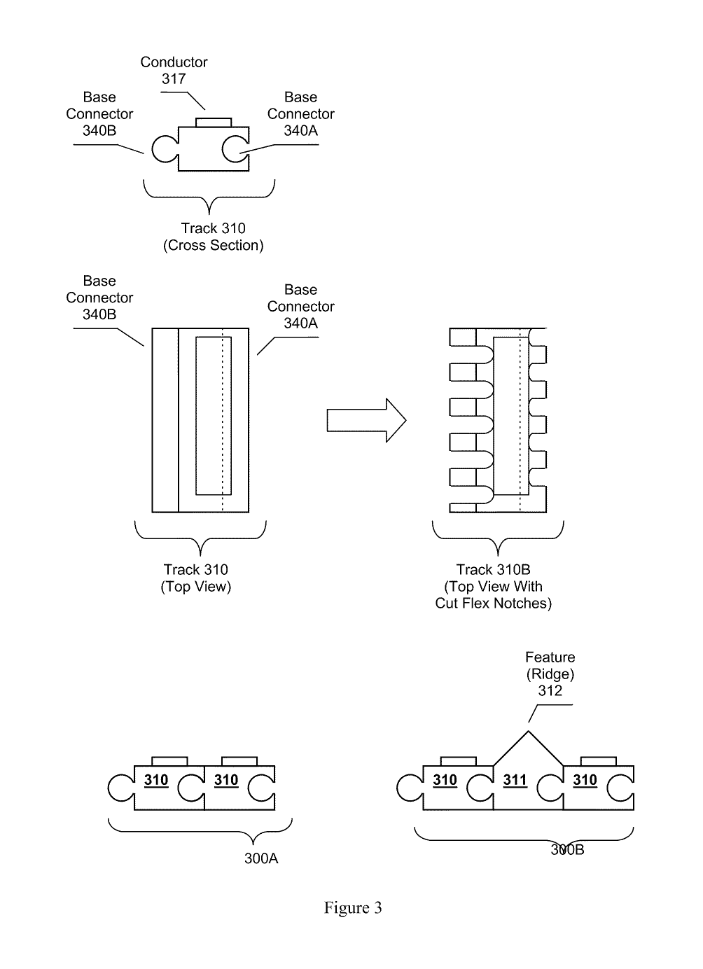

In FIG. 3, track 310 illustrates one possible embodiment of continuous base connectors 340A and 340B, referred to collectively as connectors 340. Track 310 comprises an extruded base having conductor 317 affixed to a top side the base. As shown in the cross section view of track 310, track 310 can also comprise male continuous base connector 340B and female continuous base connector 340A that can be formed during an extrusion process, possibly at time of manufacture. The top view of track 310 indicates that continuous connectors 340 substantially run along a length of track 310. The Applicant also contemplates one could modify connectors 340 after manufacture (e.g., after extrusion) to alter connectors 340. For example, notches could be cut out of base connector 340B to yield a set of repeating discrete connectors. Additionally notches could be cut into the base of track 310 from top to bottom to form a zig-zag patter, which would increase the lateral flexibility of track 310 as shown in top view 310B.

Connectors 340 provide for assembling various deterrent systems from individual, possibly fungible tracks 310. System 300A illustrates a cross section view of two fungible tracks coupled via their connectors 340 to form a dual-track deterrent system. Tracks 310 can be sized and dimensioned as necessary to target specific pests by appropriately sizing conductor strips 317, sizing the tracks base, or sizing connectors 340. When tracks 310 are coupled, conductors 317 are spaced at an appropriate distance for the pest.

It is also contemplated that a deterrent system could include additional tracks or spacers 311, with or without conductors. Spacer 311 can couple between tracks 310 to ensure conductors 317 are separated by an appropriate distance for a target pest. In some embodiments spacers 311 can be produced to with various widths to target different pests. During installation an installer can insert the proper spacer 311 for the installation. One should appreciate that that such an approach allows for configuring a system based on a single type of track to target multiple types of pests or different sizes of pests.

Spacer 311 can comprise an extruded elongated base that runs parallel to and along an entire length of tracks 310. Alternatively spacers 311 can be small discrete units deployed periodically along a length of tracks 310 as desired. In some embodiments, spacer 311 is made from the same material as tracks 310, possibly flexible extruded PVC. In other embodiments, spacer 311 could be rigid component, possibly made of metal or plastic, capable of holding tracks 310 in a proper shape on an installation surface.

Spacer 311 can also include one or more of feature 312. As shown feature 312 can include a ridge to aid in water run off or in preventing sparking between conductors 317. Additional features could include tactile features (e.g., ornamentation, textures, deterrent spikes, etc.), visual features (e.g., lights), audio features (e.g., noise generators, speakers, etc), or other features.

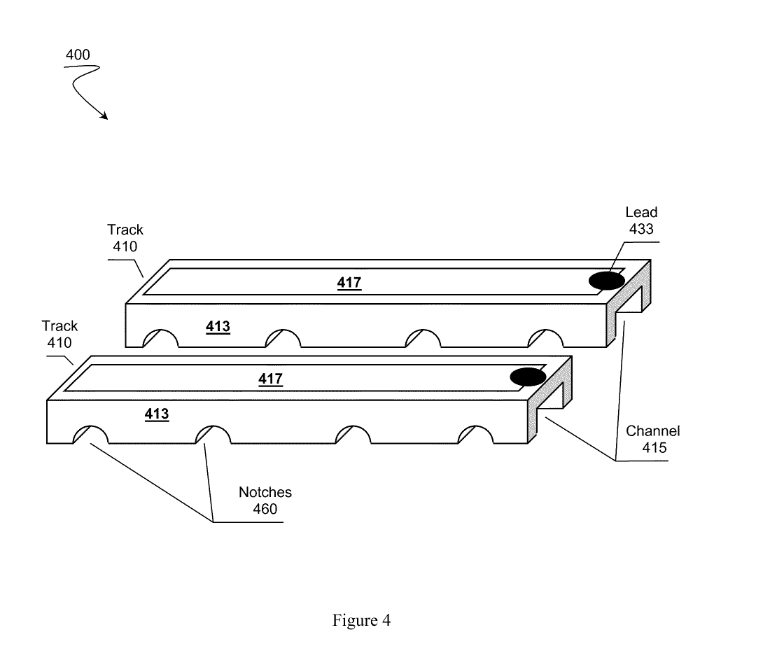

One expects the contemplated deterrent systems to be installed outside where the electrical deterrent tracks will be exposed to the weather. Such deterrent systems can be configured to be robust against the elements. For example, FIG. 4 illustrates a possible set of features for deterrent system 400 that address issues relating to drainage. As discussed previously, tracks 410 can comprise an elongated base 413 having conductors 417 affixed to a top side of base 413. Base 413 can also include one or more drainage notches 460 that run across a width of base 413 and on an underside of base 413. Notches 460 and possibly channel 415 allow water trapped between two adjacent tracks 410 to drain freely.

Although contemplated deterrent tracks comprise flexible material, such tracks can still resist retaining a bent or flexed shape. The tracks described above address some of the issues by having a narrower width than those disclosed in the art (e.g., Riddell). A narrower base width provides a greater degree of flexibility for a track to bend laterally in horizontally in a plane parallel to the base. Still, the base material could resist a tight bend.

FIG. 5 illustrates multiple rigid forms 570 having various shapes. Forms 570 can be coupled to tracks 510 to provide a rigid structure so tracks 510 can retain a desired installation shape. In the example shown rigid form 570A represents a 180 degree arc and form 570B represents a 90 degree arc. It is contemplated that forms 570 could be made having different curvatures, radii, or other shapes including sharp angled corners.

In some embodiments rigid forms 570 can be inserted internally into channel 515 as shown, or inserted within tracks 510 during manufacture. Internal forms 570 can be held in place by friction, adhesive, or other types of fasteners. Forms 570 can comprise metal, plastic, fiber glass, wood, or other rigid materials. It is also contemplated that forms 570 can be external forms that couple to track 510. For example, forms 570 could include a rigid spacer as discussed with respect to FIG. 3.

In some embodiments, forms 570 can include flexible metal or wire that are molded or otherwise inserted into tracks 510 during manufacture, and could run along one or more lengths of track 510. A flexible form 570 within track 510 allows track 510 to be bent into a desired shape in the field during installation.

Forms 570 are illustrated as providing defined ships in a horizontal plane. One should appreciate that forms 570 can also provide defined ships in other directions as well. Consider a roof top having a highly various topology. Forms 570 can be shaped a priori before installation or shaped in the field to fit a topology of a surface allowing tracks 510 to be installed with vertical bends, horizontal bends, or along other tortuous paths. Example shapes for forms can include arcs, loops, helices, or even corners.

It should be appreciated that deterrent tracks can be bent or shaped to fit a desired installation surface, which can stress the conducting strip affixed to the track's base. Preferred conducting strips also are able to flex, bend, or even contract. FIG. 6 presents various acceptable types of conductors having various degrees of flexibility, some of which are discussed in co-pending U.S. patent application to Donoho having Ser. No. 12/689,406. Conductors can be considered strips or ribbons as illustrated. However, one could also utilize wires, conducting ropes, conducting twines, or other types of conductors.

Conducting strip 622 in the form of a solid ribbon is less preferred due to lack of flexibility. Flexibility of ribbon 622 could be addressed by pleating ribbon 622 and stitching or otherwise affixing the troughs of the pleated ribbon 622 to a track base. Such a configuration provides allows ribbon 622 to yield when a track is flexed vertically, but does not fully address flexibility with respect to horizontal bends. In additional ribbon 622 could trap moisture next to the base for extended periods of time.

Woven conductors 610 provide for greater flexibility in nearly all directions and can represent a more suitable conductor. Depending on the type of conductor (e.g., braided conductor 612, warp-weft conductor 614, etc.), the conductors could have a weave that is to tight, which would also trap moister. Another possible issue with woven conductors 610 is their width tends to expand or contract as they flex (see U.S. Pat. No. 7,481,021 to Riddell) which can affect the spacing between conductors and affect the over all deterrent system's effectiveness.

Even more preferred conductors include knitted conductor 624 which comprises one or more conducting strands knitted together to form interlocking loops. Knitted conductors 624 allow for flexing in all directions while retaining a desired shape of the conductor. Rather than the width of the conductor expanding or contracting while flexing, the interlocking loops slide in and out of each other thus allowing the conducting strip to retain its desired shape. Furthermore, knitted conductors can have a high degree of porosity allowing trapped moisture to evaporate, drain, or otherwise escape.

Additional non-woven conductors 620 are also contemplated that can have high porosity. Hole mesh 626 represents a ribbon having holes. The holes allow moisture to escape. A more preferred mesh conductor includes slit mesh 628. Slit mesh 628 comprises a ribbon conductor 628A having a slit pattern cut into the ribbon periodically. When mesh 628A is flexed, the slits open allowing the conductor to stretch and form an expandable diamond mesh 628B. Such a configuration offers many, if not all, advantages of knitted conductor 624. Naturally, a slit pattern can be altered to achieve desirably expandability and can including horizontal slits as shown, chevron slits, diagonal slits, combinations of slits, or other slit patterns.

The conductors discussed above represent a single layer of conductors. One should also appreciate that multiple conductors can be combined to form a desirable conducting strip. For example, multiple knitted tubes can be nested and flattened to create a conducting strip. Multiple slit mesh conductors 628 can be folded or layered to achieve desired properties. It is also contemplated that a heterogeneous mix of conductor types can be combined, possibly where a braided tube conductor 612 could be inserted into a knitted tube conductor 624.

Conducting strips can also comprise additional features beyond merely being flat. Conducting strips can be textured, comprise knots, or other raise protrusions that could increase the chances of a pest coming into contact with the conductors. It is further contemplated that conducting strips could comprise spikes that protruded out of the strips, possible to deter birds more effectively. Examples spikes that could be adapted for us with the inventive subject matter can be found co-owned U.S. Pat. No. 7,243,465 to Donoho. Contemplates spikes could comprise conducting or non-conducting material.

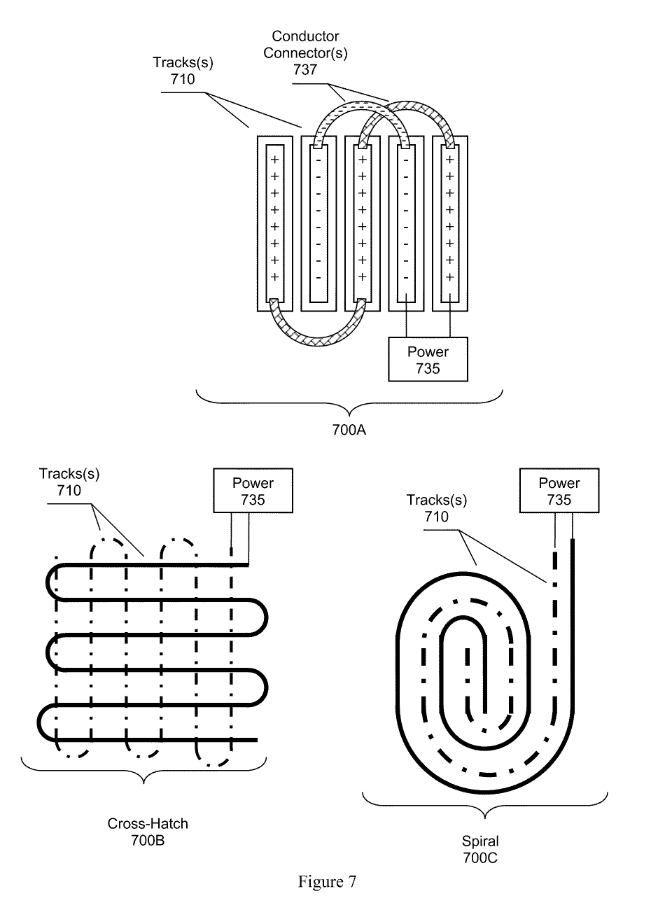

FIG. 7 presents several of the myriad possibilities for creating electrical deterrent systems based on the disclosed electric deterrent tracks. In each of the deterrent system configurations 700A through 700C tracks 710 are coupled to power source 735 which supplies a voltage difference between adjacent tracks.

Deterrent system 700A comprises an area covering array of tracks 710 spread parallel to each other. Conductors of tracks 710 can be connected via one or more of conductor connectors 737 to provide electrical continuity from one track to another so adjacent conductors have voltage differences as indicated by the symbols “+” and “−”. Note that such an array can have an odd number of tracks. Tracks 710 can be coupled together via one or more of their base connectors if desired.

Conductor connectors 737 preferably comprise a conducting material and provide electrical continuity. In some embodiments, conductor connectors 373 comprises cables or wires that connect to the conducting strips, possibly via soldering, clamps, plugs, or other types of fasteners.

Deterrent system 700B illustrates that tracks 710 can be arranged according to a cross-hatch pattern similar to a weave. Each of the tracks can over lap each other as desired. In some embodiment, the bases of tracks 710 can include notches to allow tracks 710 to fit together and lie flat, or can include bases connectors (e.g., clips, clamps, etc.) that couple the tracks together one over the other. System 700C presents a system where tracks 710 are spiraled around each other, possibly coupled with each other, to cover an area. All possible area covering arrays of tracks 710 are contemplated.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A pest deterrent system, the system comprising:
a plurality of tracks, each track comprising an elongated insulator base and a conducting strip affixed along a top surface of the base, and where the base has at least a first base connector capable of coupling the base to another base of another track;
wherein at least a first track and a second track are arranged adjacent to each other on an installation surface; and
a power coupling assembly electrically coupled to at least the conducting strips of the first and second tracks and configured to provide a voltage different difference between the conducting strips.

2. The system of claim 1, where the tracks are fungible.

3. The system of claim 2, wherein each base has a second base connector to which the first base connector couples.

4. The system of claim 1, wherein the first base connector of each track comprises mechanical base connector.

5. The system of claim 1, wherein the first base connector of each track comprises a continuous base connector running along a side of the base of each track.

6. The system of claim 1, further comprising a spacer configured to couple to the bases of the first and the second track and to provide a separation between the bases.

7. The system of claim 6, wherein the spacer comprises an elongated base and couples along the bases of the first and the second track.

8. The system of claim 1, wherein the insulator base comprises an extruded flexible polymer.

9. The system of claim 1, wherein the insulator base comprises an adhesive.

10. The system of claim 1, wherein the insulator base comprises drainage notches across a width of the base of a track and disposed on an underside of the base opposite to the top side of the base.

11. The system of claim 1, wherein the insulator base of a track comprises a channel disposed on an underside of the base opposite to the top side of the base and running along a length of the base.

12. The system of claim 1, further comprising a rigid form configured to couple to the insulator base of a track and to hold the track firm in a shape defined by the rigid form.

13. The system of claim 1, wherein the conductor strip comprises a woven conductor.

14. The system of claim 1, wherein the conductor strip comprises non-woven mesh conductor.

15. The system of claim 1, wherein the first and the second track are arranged substantially parallel to each other on the installation surface.

16. The system of claim 1, wherein the first and the second track over lap.

17. The system of claim 1, further comprising a conductor connector configured to couple the conductor strip of the first track to another conducting strip of a third track different from the first and second track.

18. The system of claim 1, wherein the plurality of tracks are arranged in an area covering array comprising at least one additional track beyond the first and second tracks.

19. The system of claim 18, wherein the area covering array comprises a cross-hatch pattern.

20. An electrical deterrent track, comprising:
an elongated insulator base having a first base connector configured to couple with a second base connector of a second insulator base; and
a conducting strip affixed to a top surface of the elongated base.

21. The track of claim 20, wherein the conducting strip is the only conducting strip disposed on the top surface of the base.

22. The track of claim 20, wherein the conducting comprises a continuous base connector.

23. The track of claim 20, wherein the base comprises the second base connector to which the first base connector can couple.

24. The track of claim 20, wherein the conducting strip comprises a non-woven conductor.

25. The track of claim 24, wherein the conducting strip comprises a non-woven mesh conductor.
